(19) United States
(12) Patent Application Publication
(10) Pub. No.: US 2008/0155024 A1
(43) Pub. Date: Jun. 26, 2008

(54) Methods And Systems For Providing For Responding To Messages Without Non-Accepted Elements Of Accepted MIME Types Based On Specifications In A Message Header

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/613,522

(22) Filed: Dec. 20, 2006

(51) Int. Cl. G06F 15/16

(52) U.S. Cl. 709/206

(57) ABSTRACT

Methods and systems are described for providing for responding to messages without non-accepted elements of accepted MIME types based on specifications in a message header. In one embodiment, a message is received from a client device. The message includes a header for specifying a MIME type that will be accepted and an element of the accepted MIME type that will not be accepted in a response to the received message. The non-accepted element is specified in the header by identifying the non-accepted element or by identifying an accepted element while omitting the non-accepted element. The header in the received message is processed to determine the accepted MIME type and the non-accepted element of the accepted MIME type. The response to the received message is generated and sent to the client device. The generated response includes the specified MIME type and excludes the non-accepted element of the accepted MIME type.

### RELATED APPLICATIONS

This application is related to U.S. patent application Ser. No. ______, titled “Methods and Systems for Providing for Responding Without at Least One of Scripts and Cookies to Requests Based on Unsolicited Request Header Indications,” filed on even date herewith, the entire disclosure of which is here incorporated by reference.

### BACKGROUND

There is common agreement that the use of client-side scripts in network-retrieved content is a security and privacy threat to the clients and users of the clients that receive and execute scripts.

A number of client-side tools, typically plug-ins or browser core functionality; provide some support for controlling the use of scripts in a client. Examples include NoScript®, a Firefox® plug-in, for controlling whether scripts from a particular domain or service provider can be executed on the client. This and similar tools can require user interaction for each script source that does not have a configured permission.

Since many sites or their services fail to operate without the use of scripts, users of these tools find themselves enabling the use of scripts in order to get a site or service to operate without knowing the full impact of their actions. Further, the use of these tools communicates little feedback to site and service providers. Users are also subject to bugs in these tools or vulnerabilities. Users often don't know whether the script management plug-ins themselves are safe, since the sources of these tools are uncertified and unknown in many instances. These same concerns can be extended to other multipurpose Internet mail extension (MIME) types in addition to scripts.

Accordingly, there exists a need for methods, systems, and computer program products for providing for responding to messages without non-accepted elements of accepted MIME types based on specifications in a message header.

### SUMMARY

Methods and systems are described for providing for responding to messages without non-accepted elements of accepted MIME types based on specifications in a message header. In one embodiment, a message is received from a client device. The message includes a header for specifying a MIME type that will be accepted and an element of the accepted MIME type that will not be accepted in a response to the received message. The non-accepted element is specified in the header by identifying the non-accepted element or by identifying an accepted element while omitting the non-accepted element. The header in the received message is processed to determine the accepted MIME type and the non-accepted element of the accepted MIME type. The response to the received message is generated and sent to the client device. The generated response includes the specified MIME type and excludes the non-accepted element of the accepted MIME type.

In another embodiment, input is received that includes at least a portion of a URI at a client device. At least a portion of the URI corresponds to a response-generating entity. A message is generated based on the received input. The message includes a header for specifying a MIME type that will be accepted and an element of the accepted MIME type that will not be accepted in a response to the received message. The non-accepted element of the accepted MIME type is specified in the header by identifying the non-accepted element or identifying an accepted element while omitting the non-accepted element. The generated message is sent to the response-generating entity for enabling the response-generating entity to process the header for responding to the received message with a response that includes the specified MIME type and excludes the non-accepted element of the accepted MIME type.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing for responding to messages without non-accepted elements of accepted MIME types based on specifications in a message header according to an embodiment of the subject matter described herein;

FIG. 2A is a block diagram illustrating a system for providing for responding to messages without non-accepted elements of accepted MIME types based on specifications in a message header according to another embodiment of the subject matter described herein;

FIG. 2B is a block diagram illustrating a system for providing for responding to messages without non-accepted elements of accepted MIME types based on specifications in a message header according to another embodiment of the subject matter described herein; and

FIG. 3 is a flow diagram illustrating a method for providing for responding to messages without non-accepted elements of accepted MIME types based on specifications in a message header according to another embodiment of the subject matter described herein.

### DETAILED DESCRIPTION

MIME is an Internet standard that extends the format of email to support text in character sets other than US-ASCII, non-text attachments, multi-part message bodies, and header information in non-ASCII character sets. Virtually all human-written Internet e-mail and a fairly large proportion of automated e-mail are transmitted via simple mail transfer protocol (SMTP) in MIME format. Internet email is so closely associated with the SMTP and MIME standards that it is sometimes called SMTP/MIME email. The content types defined by MIME standards (MIME types) are also of growing importance outside of e-mail, such as in communications protocols like hypertext transfer protocol (HTTP) for the world wide web (WWW). MIME is also a fundamental component of communication protocols, such as HTTP, which requires that data be transmitted in the context of email-like messages, even though the data may not actually be email.

Content-Type is a header that indicates the type and subtype of the message content, for example:
Content-Type: type/subtype, <parameter>

The parameter part is specified as a keyword-value pair. The combination of type and subtype is generally called a MIME type, although in some applications “Internet media type” is the favored term, indicating its applicability outside of MIME messages. A large number of file formats have registered MIME types. Any text type has an additional charset parameter that can be included to indicate the character encoding (primary use of the parameter part). A very large number of character encodings have registered MIME charset names.

The term “element” as used in this document is an identifiable part of a data resource format identified by a MIME type. An element may be structured, thus it may contain other elements. In an extensible markup language (XML) namespace, every defined tag is an element, including a top level tag. In image/jpeg images, for example, the images are stored in a format known as exchangeable image file format (EXIF). Some elements are identified by tags that include metadata keywords. Other identifiable parts of an EXIF file include various versions of an included image, such as a full-size version, a thumbnail size version, and/or a screennail size version.

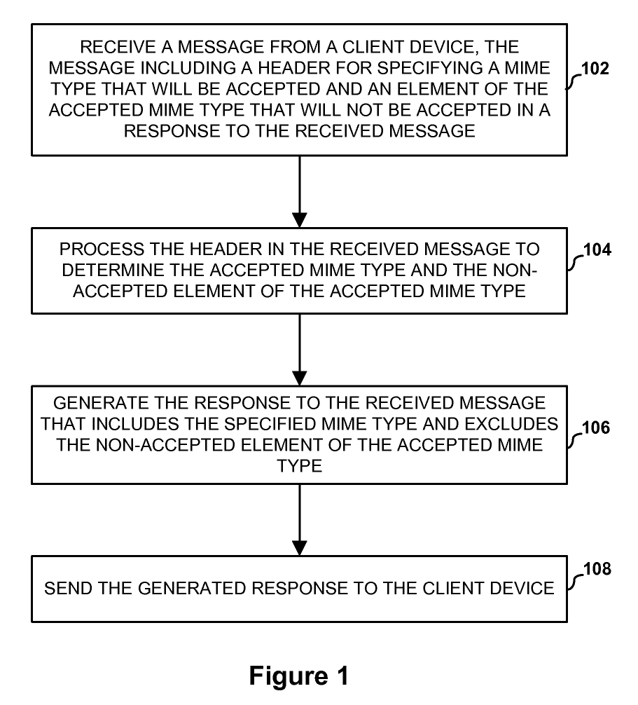

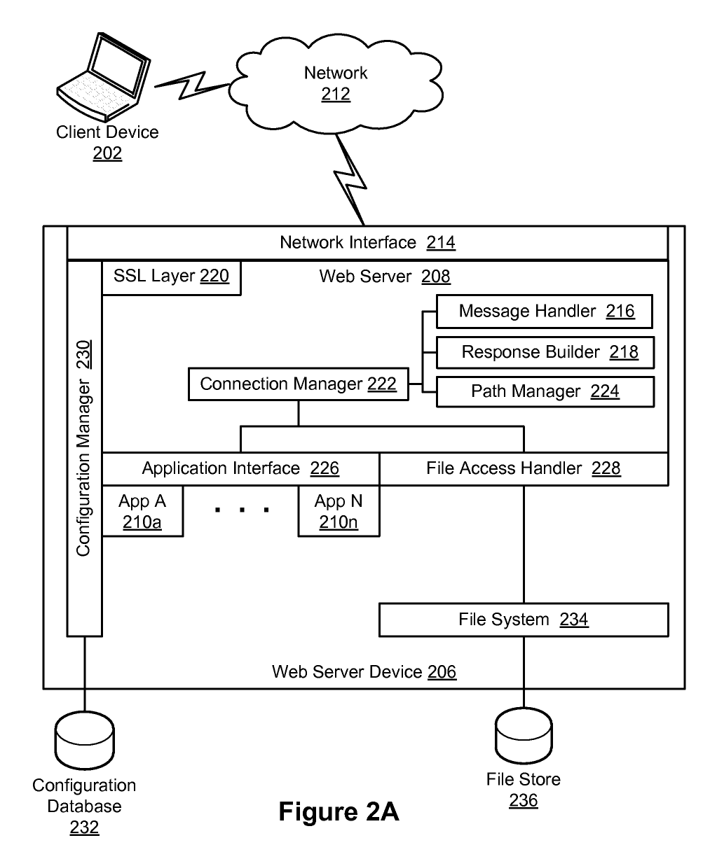

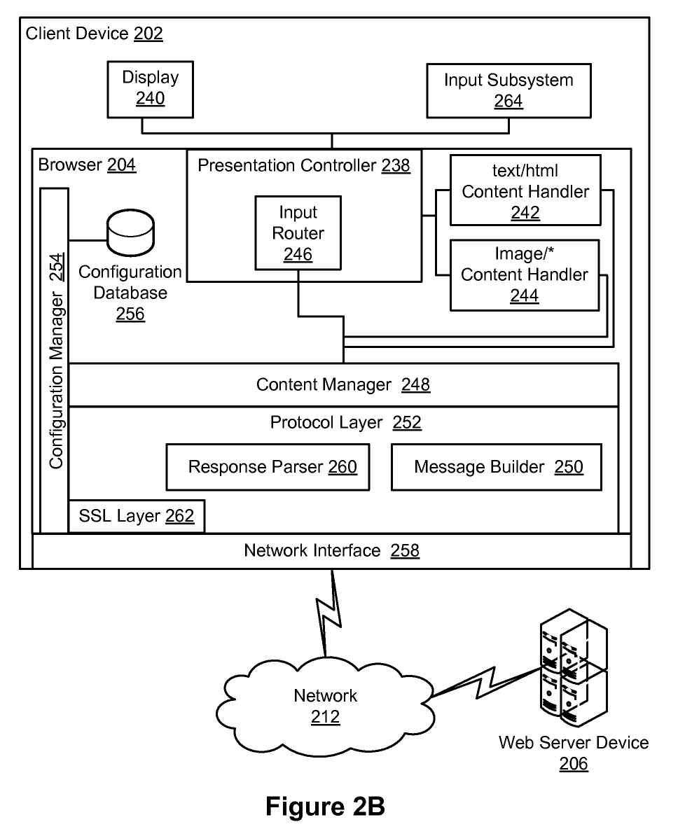

FIG. 2A is a block diagram illustrating a system for providing for responding to messages without non-accepted elements of accepted MIME types based on specifications in a message header according to an embodiment of the subject matter described herein. FIG. 1 is a flow diagram illustrating a method for providing for responding to messages without non-accepted elements of accepted MIME types based on specifications in a message header according to another embodiment of the subject matter described herein. The method illustrated in FIG. 1 can be carried out by, for example, the exemplary system illustrated in FIG. 2A.

With reference to FIG. 1, in block 102 a message is received from a client device, the message including a header for specifying a MIME type that will be accepted and an element of the accepted MIME type that will not be accepted in a response to the received message. The non-accepted element of the accepted MIME type is specified in the header by one of identifying the non-accepted element and identifying an accepted element while omitting the non-accepted element. Accordingly, a system for providing for responding to messages without non-accepted elements of accepted MIME types based on specifications in a message header includes means for receiving a message from a client device, where the message includes a header for specifying a MIME type that will be accepted and an element of the accepted MIME type that will not be accepted in a response to the received message. For example, as illustrated in FIG. 2A, a network interface component 214 is configured for receiving a message from a client device 202, the message including a header for specifying a MIME type that will be accepted and an element of the accepted MIME type that will not be accepted in a response to the received message. Once again, the non-accepted element of the accepted MIME type is specified in the header by one of identifying the non-accepted element and identifying an accepted element while omitting the non-accepted element.

Illustrated in FIG. 2A are the client device 202 and a web server device 206 that includes a web server 208 operating within an execution environment (not shown) of the web server device 206. The web server 208 is enabled to receive messages and send associated responses either on its own or in conjunction with one or more web applications 210a-210n, collectively referred to as web applications 210. Client device 202 and the web server device 206 can communicate via a network 212, which may be, for example, a direct link, a local area network (LAN), an intranet, a wide area network (WAN) such as the Internet, and the like, or any combination thereof.

In an aspect, the network interface component 214 can be configured for receiving an HTTP request. For example, as illustrated in FIG. 2A, HTTP can be used and the message can include an HTTP request, such as an HTTP GET request. The network interface component 214 can be configured for receiving the HTTP request with an HTTP header. For example, an HTTP “Accept” header can be used to provide one or more MIME types to inform the receiver of the types of data the requester is able or willing to process in a response. An example of a standard HTTP GET request message is illustrated in Example 1.

### EXAMPLE 1

GET www.mySite.us HTTP/1.1

Host: finance.myExample.us.com

User-Agent: Mozilla/5.0 (Windows; U; Windows NT 5.1; en-US; rv:1.8.0.7)

Gecko/20060909 Firefox/1.5.0.7

Accept: text/xml,application/xml,application/xhtml+xml,text/html;charset-us-ascii,text/plain;q=0.8,image/png,image/jpeg

Accept-Language: en-us,en;q=0.5

Accept-Encoding: gzip,deflate

Accept-Charset: ISO-8859-1,utf-8;q=0.7,*;q=0.7

Keep-Alive: 300

Connection: keep-alive

Cookie: sessionid=AF13B0C

The headers illustrated are all standard headers documented in Internet engineering task force (IETF) document RFC 2616, which provides a specification for HTTP version 1.1. According to IETF RFC 2046, HTTP, email, and various other protocols that use a header related to content type allow one or more parameters to be specified that modify the subtype of a MIME type identifier. In Example 1 above, in the “Accept” header, the MIME type, “text/html” is associated with a parameter “charset” with a value of “us-ascii”, which identifies to a receiver of the GET request that a response including content of type text/html is allowed, but that the character set must be US-ASCII.

Currently in Internet protocols, for example, such as HTTP, session initiation protocol (SIP), and SMTP, a client is able to identify the types of data it will accept from a sending service. This is done, for example, by the use of the Accept header in the case of HTTP that allows a client to identify, using one or more MIME types, the types of data accepted by the client. There is no facility, however, in MIME types or in any of the various headers that relate to content type, such as the Accept header and the Content-Type header, to provide more granular information about the elements associated with a MIME type. For example, there are no provisions in conventional headers for specifying a subset of the set of elements that are not in a resource or for specifying a subset of elements of the set of elements associated with a MIME type that a receiver will not accept. Since the subset of elements of a complete set of elements associated with a MIME type is a complimentary subset to the subset of elements that may be in a resource, it is clear that an identification of a subset of not accepted elements identifies the subset of accepted elements, and vice versa.

According to the subject matter described herein, the received message includes a header for specifying a MIME type that will be accepted by the client device 202, which can be the Accept header mentioned above. The header, however, also allows for specifying an element of the accepted MIME type that will not be accepted in a response to the received method. The non-accepted element of the accepted MIME type can be specified in the header in one of two ways. The non-accepted element can be specified by identifying the non-accepted element. Alternatively, the non-accepted element can be specified by identifying an accepted element while omitting the non-accepted element. That is, a subset of a complete set of elements, which may be included in a resource associated with the accepted MIME type, can be specified by identifying the non-accepted subset of elements or by identifying the accepted set of elements.

When specifying elements, modifiers for MIME subtypes may be specified. For example, the parameter part of the content type headers can be used to specify a modifier which identifies the elements of an acceptable MIME type that are not accepted by a sender of a message, which can include a content type related header, a parameter identifier specifying an element parameter, and a value identifier for specifying a not accepted element. The parameter identifier may be specified using an “element” keyword. Not accepted or accepted elements and sets of elements can have MIME type specific identifiers. For example, for the MIME type, “text/html”, a not-accepted or accepted element may be specified using a name of an element compatible with the MIME type, such as “script” for <script> elements or “p” for <p> elements. Identifiers for groups or sets of elements associated with a MIME type are also supported. For example, for the MIME type, “text/html”, an identifier “format” may be used to identify all HTML format related elements, including <b> and <i> elements.

An example using an Accept header is used herein and the example illustrates an aspect of the subject matter described herein in which the header specifies that the sender of a message will not accept HTML documents which include <script> elements, as are currently allowed by the inclusion of the “text/html” MIME type in an “Accept” header. Example 2 depicts the HTTP GET request modified to include an “element” parameter associated with the MIME type identifier, “text/html” , according to an aspect of the subject matter described herein.

### EXAMPLE 2

GET www.mySite.us HTTP/1.1

Host: finance.myExample.us.com

User-Agent: Mozilla/5.0 (Windows; U; Windows NT 5.1; en-US; rv:1.8.0.7)

Gecko/20060909 Firefox/1.5.0.7

Accept: text/xml,application/xml,text/html;element=script-frame,text/plain;element=[0-9],image/png,image/jpeg

Accept-Language: en-us,en;q=0.5

Accept-Encoding: gzip,deflate

Accept-Charset: ISO-8859-1,utf-8;q=0.7,*;q=0.7

Accept-Scripts: accept

Keep-Alive: 300

Connection: keep-alive

Cookie: sessionid=AF13B0C

In Example 2, the Accept header includes a MIME type identifier and parameter, text/html;element=script-frame. The text/html identifier in the Accept header indicates that the sender will accept HTML documents. The element=script-frame portion, as used in the example, identifies two HTML elements using a predefined separator “-”, namely, the <script> element and the <frame> element. The presence of these two identifiers indicates, in the current example, that HTML documents that do not include <script> and <frame> elements are accepted and HTML documents that include either a <script> or a <frame> element are not accepted. In an alternate example, the parameter identifier and its value can indicate that HTML documents that include elements other than <script> and <frame> elements are acceptable, thus indicating that an HTML document that includes an HTML element other than a <script> and a <frame> element is not acceptable.

In FIG. 2A, the message is received by the web server device 206 via the network 212 by the network interface component 214, which can process and remove various network protocol layer headers and trailers before the modified message is passed to an application layer protocol, such as HTTP, which can be represented by a message handler component 216 and a response builder component 218 in the example shown. In some cases, the message may be passed through an additional session layer protocol for additional services. For example, the web server device 206 can include a secure sockets layer (SSL) component 220 for supporting requests and responses using the secure HTTPS URL scheme. An HTTP request received by the web server 208 can be processed by the application protocol layer by the message handler component 216.

Returning to FIG. 1, in block 104 the header in the received message is processed to determine the accepted MIME type and the non-accepted element of the accepted MIME type. Accordingly, a system for providing for responding to messages without non-accepted elements of accepted MIME types based on specifications in a message header includes means for processing the header in the received message to determine the accepted MIME type and the non-accepted element of the accepted MIME type. For example, as illustrated in FIG. 2A, a message handler component 216 is configured for processing the header in the received message to determine the accepted MIME type and the non-accepted element of the accepted MIME type.

For example, the message handler component 216 can parse the HTTP request that includes the Accept header. The message handler component 216 can be configured to detect headers. Moreover, the message handler component 216 can be configured to detect not only the Accept header, but also to detect the value associated with the header and to determine an associated meaning. In the current example, with reference also to Example 2, the MIME type text/html, along with the element, element=script-frame, is detected and processed by the message handler component 216 to determine an associated meaning for the MIME type and element specification. Upon processing the MIME type text/html and the element, the message handler component 216 passes information corresponding to the associated meaning determination to a connection manager 222. In this case, the information indicates that HTML documents will be accepted by the sender of the message in a response to the message only if the documents do not include <script> and <frame> elements.

In the current example, the message is an HTTP request that is associated with a transmission control protocol (TCP) connection created at the request of the client device 202 and accepted by the network interface component 214 of the web server device 206 as directed by the web server 208. The connection associated with the HTTP request can remain open to provide for full-duplex communication between the client device 202 and the web server 208. The message handler component 216 can be responsible for the input stream of the full-duplex connection from the perspective of the web server 208, while the response builder component 218 can be responsible for the output stream of the connection from the web server 208 to the client device 202.

The connection manager 222 has responsibilities that can include, for example, determining a component of the web server 208 or web application 210a-n to which to direct a received request. The connection manager 222 can use a path manager 224 that when provided with at least a portion of the path part of the URI associated with a request can determine a web application from the web applications 210 available or a web server 208 component that can be responsible for handling requests associated with the at least a portion of the path part of the URI. The path manager 224 can use a table that associates at least a portion of a set of URI path parts with for example, a web application entry point, such as a java servlet through an application interface 226; or a web server 208 component, such as a file access handler 228. The table information used by the path manager 224 can be accessed via a configuration manager 230. The configuration manager 230 can be enabled to receive, store in a configuration database 232, and retrieve configuration data for components of web server 208 as well as web applications 210 and any web server 208 extensions or add-ons.

A variety of application interfaces are currently in use in addition to Java's J2EE platform interface between a J2EE container and a web server 208 including the well-known CGI interface. Most web servers supporting HTTP provide a file handler by default or as an add-on. A file handler is enabled to respond to HTTP GET, PUT, POST, and DELETE commands to operate on files and other static resources available to the web server 208 identified by a URI included in the request. The file handler 228 in the web server device 206 can use a file system 234 provided by and in conjunction with an operating system (not shown) of the web server device 206 to perform operations as directed on files in a file store 236, such as a hard-drive and other accessible resources provided through other available means on the web server device 206. Other services can be built into web servers in addition to file handlers.

In addition to routing requests, the connection manager 222 can gain access to information detected in the request by the message handler component 216 such as the URI, protocol version, the headers, and any content included in the message. In an alternate embodiment, the web server 208 can require an application 210 or web server component to parse HTTP requests and build HTTP responses. Accordingly, the detection of the Accept header may be performed by an application 210a-n, the web server 208 component, or an extension. The connection manager 222 can also provide access to the incoming and outgoing streams of the connection associated with the received HTTP request to allow a web application 210a-n or a server component to receive the content of the request. Access to the outgoing stream allows the receiving application 210a-n or a server component to generate a response with or without content in cooperation with response builder component 218.

Thus, the connection manager 222, via the application interface 226, provides an application of applications 210 or other web server 208 component the result of the determination of acceptable MIME types with not acceptable elements specified in the response. For illustration purposes, the request in the current example is directed to App A 210a. Alternatively, the message handler component 216 can parse the request for detecting the headers and make the headers available to App A 210a. The application App A 210a, in this case, must determine the meaning of the value of the text/html,element=script-frame, in the detected Accept header, if the message handler component 216 determines an Accept header is present in the request. The determination process for the application or component is analogous or functionally equivalent to the process described above used by the message handler component 216.

In an aspect, the message handler component 216 can be configured for processing a header dedicated for specifying a MIME type that will be accepted and an element of the accepted MIME type that will not be accepted in a response to the received message. For example, the message handler component 216 can be configured for processing a single header, such as the Accept header, that is dedicated for specifying a MIME type that will be accepted and an element of the accepted MIME type that will not be accepted in a response to the received message. Alternatively, the message handler component 216 can be configured for processing multiple headers and/or headers that are shared or used for other functionality for specifying a MIME type that will be accepted and an element of the accepted MIME type that will not be accepted in a response to the received message.

In another aspect, the message handler component 216 can be configured for determining the accepted MIME type includes HTML and the non-accepted element of the accepted MIME type includes one of scripts and frames. For example, returning to Example 2, the text/html identifier in the Accept header indicates that the sender will accept HTML documents and the element=script-frame portion provides the elements for specifying that HTML documents that do not include <script> and <frame> elements are accepted and HTML documents that include either a <script> or a <frame> element are not accepted. In an alternate example, for specifying in the header, the parameter identifier and its value can indicate that HTML documents that include elements other than <script> and <frame> elements are acceptable, thus specifying that an HTML document that includes an HTML element other than a <script> and a <frame> element is not acceptable.

In another aspect, the message handler component 216 can be configured for determining the accepted MIME type and the non-accepted element of the accepted MIME type from a MIME type format that includes a subtype modifier for specifying the non-accepted element. Instead of using content type related header parameters, the format of MIME types can be extended to support subtype modifiers as elements. This allows the elements to become part of the MIME type indicator, which can be used in applications where content headers are typically not used. For example the following exemplary format can be used:
TYPE/SUBTYPE/[INCLUDED ELEMENT|˜EXCLUDED ELEMENT[;]]*

Some exemplary new and extended MIME type elements and formats based on the subtype modifiers are provided below, each followed by a brief description of an exemplary use:
a. text/html/-script (HTML without <script> elements)
b. img/jpeg/tags (JPEG image which can only contain the main image and metadata. No lower resolution thumbnails, screennails, etc are allowed.
c. text/xml/http://example.com/schemas/example (an XML file where the elements are specified by the schema found at http:H/example.com/schemas/example)
d. application/ms-word/-macros (a Microsoft Word® compatible resource that does not contain any macros)

For HTTP, an advantage of extended MIME specifications is that no new headers, for example, may be required to exclude scripts from content. In one aspect, if an extended format is used, all elements of the indicated type are allowed or not allowed as indicated. Wildcard characters are allowed in the MIME type indicator, including the extended format, as they are allowed in the current format. This allows backwards compatibility with existing implementations. Consistent with the philosophy of HTTP, when a user agent encounters a header it doesn't understand, the header can be ignored.

In another aspect, the message handler component 216 can be configured for determining from the header at least one of supported and unsupported scripting languages. A list of supported scripting languages and/or a list of unsupported script languages may be listed in the associated header and determined by the message handler component 216.

In another aspect, the message handler component 216 can be configured for determining from the header at least one of a domain, a site, a partial URI, and a URI that the non-accepted element of the accepted MIME type is one of limited to and prohibited from. That is, settings for the accept header may be domain, site, partial URI, and/or complete URI specific.

In another aspect, the message handler component 216 can be configured for determining from the header one of allowed and disallowed script-based operations. Identifiers may be used to restrict the operation of accepted scripts. For example, “no-cookie-access” indicates that scripts that are accepted will not be allowed access to any stored cookies, nor be able to create and store new cookies.

In another aspect, the message handler component 216 can be configured for determining from the header an authorization for a script based on an electronic signature. For example, the header can specify whether a script must be signed and provide a list of authorized signers in order for a script to be accepted by the message handler component 216.

Returning to FIG. 1, in block 106 a response to the received message is generated that includes the specified MIME type and excludes the non-accepted element of the accepted MIME type. Accordingly, a system for providing for responding to messages without non-accepted elements of accepted MIME types based on specifications in a message header includes means for generating the response to the received message that includes the specified MIME type and excludes the non-accepted element of the accepted MIME type. For example, as illustrated in FIG. 2A, a response builder component 218 is configured for generating the response to the received message that includes the specified MIME type and excludes the non-accepted element of the accepted MIME type.

For illustration purposes, the received message can be routed by the connection manager 222 to web application App A 210a, via application interface 226 based on a determination by the path manager 224 using at least a portion of the path of the URI included in the request. App A 210a can access information in the message, including the URI, headers, and any content that is included in the message via application interface 226. App A 210a, as is typical with most web applications, can determine a type for an HTTP command, which in this example is a GET command. App A 210a can then invoke a GET command handler (not shown) that, based on the URI, performs an operation. App A 210a can use the results of the operation and initiate a process for building a response to the received request, where at least a portion of the operation results are designated as content for the response. App A 210, via application interface 226 and connection manager 222, can invoke response builder component 218 using parameters provided by App A 210a and/or information in the message retrieved from the message handler component 216.

Based on a determination that HTML page with <script> and <frame> elements are acceptable, App A 210a retrieves or generates a version of a web page that excludes <script> and <frame> elements based on the request message. Some applications return a standard page indicating that the site cannot conform to the request, and in particular, many applications currently indicate they will not operate without scripts.

App A 210a can use the application interface 226 to set a Content-Type header to include the text/html,element=script-frame value associated with at least a portion of the content for indicating it conforms with the restriction indicated in the received requests Accept header. App A 210a may set any other headers needed and set an HTTP return code in a response built by the response builder component 218 via the application interface 226 through connection manager 222 to the response builder component 218.

In an aspect, the response builder component 218 can be configured for generating at least one other subsequent communication that, as specified in the message, excludes the non-accepted element of the accepted MIME type. Each header can provide an indication associated only with the response to a message in which a header was included. Alternatively, a header may provide an indication that covers a specified duration or the life of a session. If an indication spans the life of a session, a session ID can be identified in the header.

Returning to FIG. 1, in block 108 the generated response is sent to the client device 202. Accordingly, a system for providing for responding to messages without non-accepted elements of accepted MIME types based on specifications in a message header includes means for sending the generated response to the client device 202. For example, as illustrated in FIG. 2A, the network interface component 214 is configured for sending the generated response to the client device 202.

For example, App A 210a can provide a signal to the response builder component 218 to forward the response to the network interface component 214 to forward the response or finish sending any remaining buffered portion of the response by closing the output stream of the associated connection. The output stream as mentioned earlier was provided to App A 210a via the application interface 226 when the connection manager 222 routed the received request to App A 210a.

The web server 208 can be configured to start transmitting the response to the client device 202 when App A 210a begins writing content to the output stream of the associated connection or can be configured to buffer the entire response, including the content, until an indication is received to send the data in a buffer (not shown). The indication that the response is complete and should be sent can be the closing of the output stream by App A 210a in the embodiment described. The output stream can be managed by the response builder component 218 and/or the network interface component 214, which together or singly can buffer the associated data and send the response.

After completing the setup of the response, App A 210a can add content to the response, if there is any, by writing the content to the output stream associated with the connection of the received request. In the example, App A 210a sends a web page as content as a result of App A's 210a operation in processing the request. App A 210a provides the MIME type, text.html, of the page, and writes the page to the output stream. This may cause the response builder component 218 to forward the response to the network interface component 214 to begin transmitting the response or the response builder component 218 may buffer the response until it receives a signal to flush its buffers. When App A 210a writes the final portion of the response content to the output stream, App A 210a closes the output stream to cause the response builder component 218 to forward the response to the network interface component 214 to begin transmitting the response or the remainder of the response to the client device 202. The response builder component 218 can forward the data to the network interface component 214 by passing one or more data buffers associated with a TCP port number to an interface enabling interaction with the network interface component 214. Sockets is an interface that can be used by applications and services in using a network interface component 214 supporting the TCP/IP protocol.

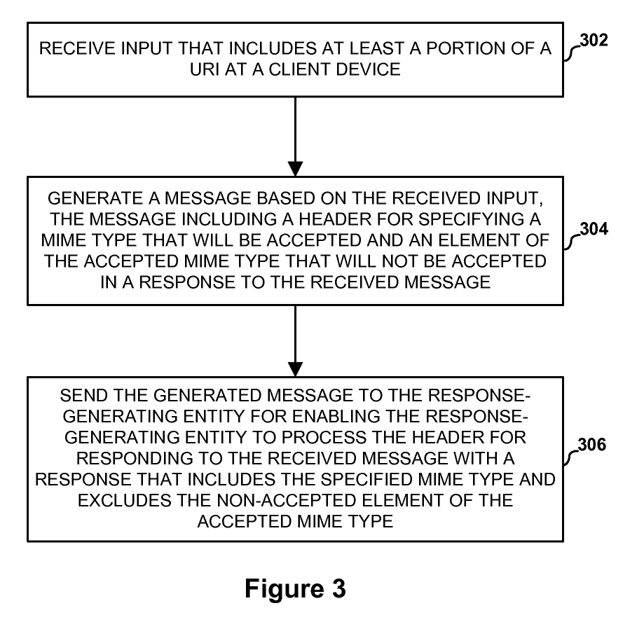

FIG. 2B and FIG. 3 illustrate exemplary systems and methods from the perspective of the sender of a message (e.g., a request). FIG. 2B is a block diagram illustrating a system for providing for responding to messages without non-accepted elements of accepted MIME types based on specifications in a message header according to an exemplary embodiment of the subject matter described herein. FIG. 3 is a flow diagram illustrating a method for providing for responding to messages without non-accepted elements of accepted MIME types based on specifications in a message header according to another exemplary embodiment of the subject matter described herein. The method illustrated in FIG. 2B can be carried out by, for example, the exemplary system illustrated in FIG. 3.

With reference to FIG. 3, in block 302 input is received that includes at least a portion of a URI at a client device 202. At least a portion of the URI corresponds to a response-generating entity. Accordingly, a system for providing for responding to messages without non-accepted elements of accepted MIME types based on specifications in a message header includes means for receiving input that includes at least a portion of a URI at a client device 202, where at least a portion of the URI corresponds to a response-generating entity. For example, as illustrated in FIG. 2B, an input subsystem component 264 is configured for receiving input that includes at least a portion of a URI at a client device 202.

For example, the browser 204 in the client device 202 can receive a URL via an input subsystem component 264 of the client device 202 as presented on a display 240 in a location bar presented by the browser 204 under the direction of a presentation controller 238 of the browser 204. Alternatively, a URL and a specified HTTP command type can be received via the input subsystem component 264 as a result of, for example, receiving a selection of a link displayed on a web page on display 240 by presentation controller 238 as directed by one or more content handlers of the browser 204, such as an HTML content handler 242 and/or an image content handler 244. The input subsystem component 264 can pass a representation of the input received to an input router 246 included in the presentation controller 238. If the input is received via the location bar, the input router 246 can pass the input to a content manager 248 for processing. If the input is received via a web page, the input router 246 can pass the input to the content handler associated with a portion of the web page corresponding to the received input, such as the HTML content handler 242. The HTML content handler 242, for example, can pass the input received, including at least a portion of a URI to the content manager 248.

Returning to FIG. 3, in block 304 a message is generated based on the received input, the message including a header for specifying a MIME type that will be accepted and an element of the accepted MIME type that will not be accepted in a response to the received message. The non-accepted element of the accepted MIME type is specified in the header by one of identifying the non-accepted element and identifying an accepted element while omitting the non-accepted element. Accordingly, a system for providing for responding to messages without non-accepted elements of accepted MIME types based on specifications in a message header includes means for generating a message based on the received input, the message including a header for specifying a MIME type that will be accepted and an element of the accepted MIME type that will not be accepted in a response to the received message, where the non-accepted element of the accepted MIME type is specified in the header by one of identifying the non-accepted element and identifying an accepted element while omitting the non-accepted element. For example, as illustrated in FIG. 2B, a message builder component 250 is configured for generating a message based on the received input, the message including a header for specifying a MIME type that will be accepted and an element of the accepted MIME type that will not be accepted in a response to the received message.

The content manager 248 can route the received input based on the URI scheme of the at least a portion of a URI received. A complete URI can be generated from a partial URI based on a sender of the portion of the web page associated with the input received that resulted in a request to the content manager 248. Input received via the location bar can result in a complete URI being sent to the content manager 248 for building a request.

In one aspect, the message builder component 250 can be configured for generating an HTTP request with an HTTP header. In the current example, the scheme of the URI received by the content manager 248 is the HTTP scheme and the command indication received by the content manager 248 indicates an HTTP GET request is to be generated and sent. As a result, the content manager 248 routes the input including the URI and the command indication to a message builder component 250 of a protocol layer 252, which in this example is an HTTP protocol layer. The message builder component 250 generates an HTTP GET command based on the URI settings headers in the request as determined by the browser's 204 policy and configuration.

A configuration manager 254 manages configuration data for the browser 204 and can provide support for receiving configuration data as input and for storing configuration data in a configuration database 256. In the current example, configuration settings are supported that allow a user to specify a MIME type that will be accepted and an element of the accepted MIME type that will not be accepted in a response to the received message, where the non-accepted element of the accepted MIME type is specified in the header by one of identifying the non-accepted element and identifying an accepted element while omitting the non-accepted element. Based on these settings retrieved via the configuration manager 254 and stored in the configuration database 256, the message builder component 250 can determine a MIME acceptable in response to the message. The message builder component 250 can add the corresponding Accept header to the message, which in this case is an HTTP GET command.

Using a method described in United States Published Patent Application No. 2006/0014520, a user may control these header settings using scheme modifiers provided as a part of a URI entered via the location bar. Web developers may use scheme modifiers in links in web pages to indicate page preferences for these settings.

In one aspect, data affecting the settings received via the location bar override settings managed by the configuration manager 254 and settings managed by the configuration manager 254 override the preferences indicated by data included in a link of a web page. One skilled in the art can appreciate that settings can be maintained by the configuration manager 254 that are defaults for the browser, settings can be maintained on a domain basis, a URI pattern basis, or partial URI basis, and/or on a full URI basis. This list of options is not meant to be exhaustive.

The message builder component 250 can be configured for generating a message having a header for specifying any of the additional information discussed above. For example, in one aspect, the message builder component 250 can be configured for generating an HTTP request with an HTTP header. In another aspect, the message builder component 250 can be configured for generating a message having a header dedicated for specifying a MIME type that will be accepted and an element of the accepted MIME type that will not be accepted in a response to the received message. In another aspect, the message builder component 250 can be configured for specifying in the header that the accepted MIME type includes HTML and the non-accepted element of the accepted MIME type includes one of scripts and frames. In another aspect, the message builder component 250 can be configured for specifying in the header the accepted MIME type and the non-accepted element of the accepted MIME type using a MIME type format that includes a subtype modifier for specifying the non-accepted element. In another aspect, the message builder component 250 can be configured for specifying in the header that at least one other subsequent communication from the response-generating entity excludes the non-accepted element of the accepted MIME type. In another aspect, the message builder component 250 can be configured for specifying in the header at least one of supported and unsupported scripting languages. In another aspect, the message builder component 250 can be configured for specifying in the header at least one of a domain, a site, a partial URI, and a URI that the non-accepted element of the accepted MIME type is one of limited to and prohibited from. In another aspect, the message builder component 250 can be configured for specifying in the header one of allowed and disallowed script-based operations. In another aspect, the message builder component 250 can be configured for specifying in the header an authorization for a script based on an electronic signature. In another aspect, the message builder component 250 can be configured for determining the non-accepted element of the accepted MIME type from the at least a portion of the URI. Each of these aspects is described above in further detail and their description is therefore not repeated here.

Returning to FIG. 3, in block 306 the generated message is sent to the response-generating entity for enabling the response-generating entity to process the header for responding to the received message with a response that includes the specified MIME type and excludes the non-accepted element of the accepted MIME type. Accordingly, a system for providing for responding to messages without non-accepted elements of accepted MIME types based on specifications in a message header includes means for sending the generated message to the response-generating entity for enabling the response-generating entity to process the header for responding to the received message with a response that includes the specified MIME type and excludes the non-accepted element of the accepted MIME type. For example, as illustrated in FIG. 2B, a network interface component 258 can be configured for sending the generated message to the response-generating entity for enabling the response-generating entity to process the header for responding to the received message with a response that includes the specified MIME type and excludes the non-accepted element of the accepted MIME type.

Returning again to the current example, the message builder component 250 can create a connection to the receiver by invoking either the network interface component 258, which can support, for example, TCP/IP, and can invoke a session layer protocol, such as SSL 262. In the current example, the network interface component 258 is called to create a connection to web server 208 in web server device 206 over network 212.

The network interface component 258 sends the HTTP GET request to the web server 208 using the connection created, which can include support by the message builder component 250. The processing of the HTTP GET request is described above, including a description of the generation and sending of a response conforming to the indicated MIME type and element parameter in the Accept header setting.

In another aspect, a response parser component 260 can be included and configured for, responsive to receiving a response to the message from the response-generating entity, determining whether the response includes the non-accepted element of the accepted MIME type, and not accepting the response responsive to a determination that the response includes the non-accepted element of the accepted MIME type. For example, a response may be received by the client device 202 via network interface component 258 and provided to the protocol layer 252, such as an HTTP layer, via the connection created for sending the request. The response can be handled in the protocol layer 252 by a response parser component 260. The response parser component 260 can parse and validate the response and can enforce the setting of the Accept headers. For example, the response parser component 260 can correlate requests with responses and reject responses that don't conform to the header specifications.

When a response does not conform, the response parser component 260 can discard the response and provide an error indication to the content manger 248, which can route the error indication to a content handler providing support for the MIME types of error indications. The content handler can present the error indication via the presentation controller 238 and display 240. In another case, the response parser component 260 can cause the browser 204 to present a warning allowing a user to provide an indication as to whether the response should be fully processed, which can include presenting the content of the response.

For responses that do conform to the indicators provided in the request, the response parser component 260 can provide at least a portion of the response to the content manger 248 for routing to one or more content handlers providing support for the MIME type(s) of the response message content. The content handlers 242, 244 can present data that each receives according to its MIME type and relationships to other portions of a web page of which the data is a part.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing for responding to messages without non-accepted elements of accepted MIME types based on specifications in a message header, the method comprising:
receiving a message from a client device, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element;
processing the header in the received message to determine the accepted MIME type and the non-accepted element of the accepted MIME type; generating the response to the received message that includes the specified MIME type and excludes the non-accepted element of the accepted MIME type; and
sending the generated response to the client device.

2. The method of claim 1 wherein receiving a message includes receiving an HTTP request and processing the header in the received message includes processing an HTTP header to determine the accepted MIME type and the non-accepted element of the accepted MIME type.

3. The method of claim 1 wherein processing the header in the received message includes processing a header dedicated for specifying a MIME type that will be accepted and an element of the accepted MIME type that will not be accepted in a response to the received message.

4. The method of claim 1 wherein processing the header in the received message includes determining the accepted MIME type includes HTML and the non-accepted element of the accepted MIME type includes one of scripts and frames.

5. The method of claim 1 wherein processing the header in the received message includes determining the accepted MIME type and the non-accepted element of the accepted MIME type from a MIME type format that includes a subtype modifier for specifying the non-accepted element.

6. The method of claim 1 wherein processing the header in the received message to determine the accepted MIME type and the non-accepted element of the accepted MIME type includes determining from the header at least one of supported and unsupported scripting languages.

7. The method of claim 1 wherein processing the header in the received message to determine the accepted MIME type and the non-accepted element of the accepted MIME type includes determining from the header at least one of a domain, a site, a partial URI, and a URI that the non-accepted element of the accepted MIME type is one of limited to and prohibited from.

8. The method of claim 1 wherein processing the header in the received message to determine the accepted MIME type and the non-accepted element of the accepted MIME type includes determining one of allowed and disallowed script-based operations.

9. The method of claim 1 wherein processing the header in the received message to determine the accepted MIME type and the non-accepted element of the accepted MIME type includes determining an authorization for a script based on an electronic signature.

10. The method of claim 1 comprising generating at least one other subsequent communication that, as specified in the request, excludes the non-accepted element of the accepted MIME type.

11. A method for providing for responding to messages without non-accepted elements of accepted MIME types based on specifications in a message header, the method comprising:
receiving input that includes at least a portion of a URI at a client device, wherein at least a portion of the URI corresponds to a response-generating entity;
generating a message based on the received input, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element; and
sending the generated message to the response-generating entity for enabling the response-generating entity to process the header for responding to the received message with a response that includes the specified MIME type and excludes the non-accepted element of the accepted MIME type.

12. The method of claim 11 wherein generating a request includes generating an HTTP request with an HTTP header.

13. The method of claim 11 wherein generating a message includes generating a message having a header dedicated for specifying a MIME type that will be accepted and an element of the accepted MIME type that will not be accepted in a response to the received message.

14. The method of claim 11 wherein generating a message includes specifying the accepted MIME type includes HTML and the non-accepted element of the accepted MIME type includes one of scripts and frames.

15. The method of claim 11 wherein generating a message includes specifying the accepted MIME type and the non-accepted element of the accepted MIME type using a MIME type format that includes a subtype modifier for specifying the non-accepted element.

16. The method of claim 11 wherein generating a message includes specifying that at least one other subsequent communication from the response-generating entity excludes the non-accepted element of the accepted MIME type.

17. The method of claim 11 wherein generating a message includes specifying at least one of supported and unsupported scripting languages.

18. The method of claim 11 wherein generating a message includes specifying at least one of a domain, a site, a partial URI, and a URI that the non-accepted element of the accepted MIME type is one of limited to and prohibited from.

19. The method of claim 11 wherein generating a message includes specifying one of allowed and disallowed script-based operations.

20. The method of claim 11 wherein generating a message includes specifying an authorization for a script based on an electronic signature.

21. The method of claim 11 wherein generating a message includes determining the non-accepted element of the accepted MIME type from the at least a portion of the URI.

22. The method of claim 11 comprising:
receiving a response to the message from the response-generating entity;
determining whether the response includes the non-accepted element of the accepted MIME type; and
not accepting the response responsive to a determination that the response includes the non-accepted element of the accepted MIME type.

23. A system for providing for responding to messages without non-accepted elements of accepted MIME types based on specifications in a message header, the system comprising:
means for receiving a message from a client device, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element;
means for processing the header in the received message to determine the accepted MIME type and the non-accepted element of the accepted MIME type;
means for generating the response to the received message that includes the specified MIME type and excludes the non-accepted element of the accepted MIME type; and
means for sending the generated response to the client device.

24. A system for providing for responding to messages without non-accepted elements of accepted MIME types based on specifications in a message header, the system comprising:
a network interface component configured for receiving a message from a client device, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element;
a message handler component configured for processing the header in the received message to determine the accepted MIME type and the non-accepted element of the accepted MIME type;
a response builder component configured for generating the response to the received message that includes the specified MIME type and excludes the non-accepted element of the accepted MIME type; and
the network interface component configured for sending the generated response to the client device.

25. The system of claim 24 wherein the network interface component is configured for receiving an HTTP request and the message handler component is configured for processing an HTTP header to determine the accepted MIME type and the non-accepted element of the accepted MIME type.

26. The system of claim 24 wherein the message handler component is configured for processing a header dedicated for specifying a MIME type that will be accepted and an element of the accepted MIME type that will not be accepted in a response to the received message.

27. The system of claim 24 wherein the message handler component is configured for determining the accepted MIME type includes HTML and the non-accepted element of the accepted MIME type includes one of scripts and frames.

28. The system of claim 24 wherein the message handler component is configured for determining the accepted MIME type and the non-accepted element of the accepted MIME type from a MIME type format that includes a subtype modifier for specifying the non-accepted element.

29. The system of claim 24 wherein the message handler component is configured for determining from the header at least one of supported and unsupported scripting languages.

30. The system of claim 24 wherein the message handler component is configured for determining from the header at least one of a domain, a site, a partial URI, and a URI that the non-accepted element of the accepted MIME type is one of limited to and prohibited from.

31. The system of claim 24 wherein the message handler component is configured for determining from the header one of allowed and disallowed script-based operations.

32. The system of claim 24 wherein the message handler component is configured for determining from the header an authorization for a script based on an electronic signature.

33. The system of claim 24 wherein the response builder component is configured for generating at least one other subsequent communication that, as specified in the request, excludes the non-accepted element of the accepted MIME type.

34. A system for providing for responding to messages without non-accepted elements of accepted MIME types based on specifications in a message header, the system comprising:
means for receiving input that includes at least a portion of a URI at a client device, wherein at least a portion of the URI corresponds to a response-generating entity;
means for generating a message based on the received input, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element; and
means for sending the generated message to the response-generating entity for enabling the response-generating entity to process the header for responding to the received message with a response that includes the specified MIME type and excludes the non-accepted element of the accepted MIME type.

35. A system for providing for responding to messages without non-accepted elements of accepted MIME types based on specifications in a message header, the system comprising:
an input subsystem component configured for receiving input that includes at least a portion of a URI at a client device, wherein at least a portion of the URI corresponds to a response-generating entity;
a message builder component configured for generating a message based on the received input, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element; and
a network interface component configured for sending the generated message to the response-generating entity for enabling the response-generating entity to process the header for responding to the received message with a response that includes the specified MIME type and excludes the non-accepted element of the accepted MIME type.

36. The system of claim 35 wherein the message builder component is configured for generating an HTTP request with an HTTP header.

37. The system of claim 35 wherein the message builder component is configured for specifying in the header a MIME type that will be accepted and an element of the accepted MIME type that will not be accepted in a response to the received message.

38. The system of claim 35 wherein the message builder component is configured for specifying in the header that the accepted MIME type includes HTML and the non-accepted element of the accepted MIME type includes one of scripts and frames.

39. The system of claim 35 wherein the message builder component is configured for specifying in the header the accepted MIME type and the non-accepted element of the accepted MIME type using a MIME type format that includes a subtype modifier for specifying the non-accepted element.

40. The system of claim 35 wherein the message builder component is configured for specifying in the header that at least one other subsequent communication from the response-generating entity excludes the non-accepted element of the accepted MIME type.

41. The system of claim 35 wherein the message builder component is configured for specifying in the header at least one of supported and unsupported scripting languages.

42. The system of claim 35 wherein the message builder component is configured for specifying in the header at least one of a domain, a site, a partial URI, and a URI that the non-accepted element of the accepted MIME type is one of limited to and prohibited from.

43. The system of claim 35 wherein the message builder component is configured for specifying in the header one of allowed and disallowed script-based operations.

44. The system of claim 35 wherein the message builder component is configured for specifying in the header an authorization for a script based on an electronic signature.

45. The system of claim 35 wherein the message builder component is configured for determining the non-accepted element of the accepted MIME type from the at least a portion of the URI.

46. The system of claim 35 comprising a response parser component configured for, responsive to receiving a response to the message from the response-generating entity:
determining whether the response includes the non-accepted element of the accepted MIME type; and
not accepting the response responsive to a determination that the response includes the non-accepted element of the accepted MIME type.

47. A computer readable medium including a computer program, executable by a machine, for providing for responding to messages without non-accepted elements of accepted MIME types based on specifications in a message header, the computer program comprising executable instructions for:
receiving a message from a client device, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element;
processing the header in the received message to determine the accepted MIME type and the non-accepted element of the accepted MIME type;
generating the response to the received message that includes the specified MIME type and excludes the non-accepted element of the accepted MIME type; and
sending the generated response to the client device.

48. A computer readable medium including a computer program, executable by a machine, for providing for responding to messages without non-accepted elements of accepted MIME types based on specifications in a message header, the computer program comprising executable instructions for:
receiving input that includes at least a portion of a URI at a client device, wherein at least a portion of the URI corresponds to a response-generating entity;
generating a message based on the received input, the message including a header for specifying a MIME type that will be accepted and an element of the accepted MIME type that will not be accepted in a response to the received message, wherein the non-accepted element of the accepted MIME type is specified in the header by one of identifying the non-accepted element and identifying an accepted element while omitting the non-accepted element; and
sending the generated message to the response-generating entity for enabling the response-generating entity to process the header for responding to the received message with a response that includes the specified MIME type and excludes the non-accepted element of the accepted MIME type.
